(19) United States
(12) Patent Application Publication
(10) Pub. No.: US 2008/0243991 A1
(43) Pub. Date: Oct. 2, 2008

(54) Content Purchase and Transfer Management for Reader Device

(76) Inventors: Thomas A. Ryan, Los Gatos, CA (US); Gregg E. Zehr, Los Gatos, CA (US)

Correspondence Address: LEE & HAYES, PLLC, 421 W. RIVERSIDE AVE, STE 500, SPOKANE, WA, 99201, US

(21) Appl. No.: 11/693,554

(22) Filed: Mar. 29, 2007

(51) Int. Cl. G06F 15/16

(52) U.S. Cl. 709/203

(57) ABSTRACT

A technique in which content is supplied to an electronic reader device from a server is described. The reader device establishes a connection with the server and then automatically transmits its identification information to the server. In response, the server provides the electronic reader device with a representation corresponding to electronic content available from the server for purchase and/or display. The electronic reader device displays the representation wherein a user of the client electronic device purchases content by selecting the representation on the display. The server acknowledges the selection and/or purchase and automatically provides the electronic reader device with the corresponding electronic content for display.

### BACKGROUND

Electronic distribution of information has gained in importance with the proliferation of personal computers, and has undergone a tremendous upsurge in popularity as the Internet has become widely available. With the widespread use of the Internet, it has become possible to distribute large, coherent units of information, such as books, using electronic technologies. Books and other printed content distributed using electronic technologies are commonly referred to as electronic books (“eBooks”). Various entities make eBooks available for download over ordinary network connections, such as broadband and dialup connections.

EBooks are displayed and read on a variety of different display devices, such as computer monitors, portable digital assistants (PDAs), pocket personal computers (PCs), and specialized eBook reader devices, for example. Typical electronic reader devices attempt to mimic the experience of reading a conventional paper book or other printed works through display of electronic information on one or more electronic displays. A typical electronic reader device is a handheld digital device having a liquid crystal display panel, having enough memory and having processing capability to store several eBooks. Such a device is capable of retrieving and displaying an eBook or portion of an eBook for reading.

There are some advantages to using an electronic reader device over conventional paper books or other printed works. An electronic reader device is often capable of storing a number of complete unabridged works. Therefore, an electronic reader device containing a number of stored works weighs significantly less than the same number of printed works. This makes an electronic reader device a particularly attractive alternative to printed works for travel, educational purposes, and professional business use. Also, because electronic reader devices do not require the use of paper products, they are generally offered at a lower price than their printed counterparts. Furthermore, the use of electronic reader devices in conjunction with printed works may be beneficial to the ecosystem, by reducing a number of books produced using paper products.

To date, however, electronic reader devices and the use of electronic reader device in general have not achieved widespread consumer acceptance. This is mainly attributable to the design and implementation particulars of conventional electronic reader devices.

For instance, the lack of the ability to purchase and obtain content quickly may be one reason the use of conventional electronic reader devices has not gained widespread popularity. When a user attempts to purchase content using a conventional electronic reader device, the user may have to connect to a local computer, then have to manually enter various user specific information into the reader to log onto a server computer through the local computer, wait for the electronic reader device to log onto a network, again enter various user specific information to purchase the new content, download the new content for the electronic reader device and finally launch an application to display the content. Retrieval of content may require time and effort on the part of the user, which degrades the electronic reader device user experience.

The preceding description of various disadvantages of conventional electronic reader devices was provided herein for contextual reasons only.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 depicts an illustrative architecture in which electronic book (“eBook”) reader devices is implemented. The architecture includes multiple electronic reader devices coupled via a network to a content server.

FIG. 2 is a block diagram depicting a server database in the content server shown in FIG. 1.

FIG. 3 is a block diagram depicting selected modules in an embodiment of an administrative client shown in FIG. 1.

FIG. 4 depicts a screen rendering of an embodiment of a display interface on the administrative client shown in FIG. 3.

FIG. 5 is a block diagram depicting selected modules in an embodiment of an electronic reader device shown in FIG. 1.

FIGS. 6a and 6b depict screen renderings of embodiments of a user interface of an electronic reader device shown in FIG. 1.

FIGS. 7a and 7b depicts a flow diagram of a process for providing content from a content server to an electronic reader device shown in FIG. 1, where FIG. 7a depicts the flow diagram executed by the server and FIG. 7b depicts the flow diagram executed by the electronic reader device.

FIG. 8 depicts a flow diagram of a process for initiating a content server to provide content to the electronic reader device shown FIG. 1.

### DETAILED DESCRIPTION

This disclosure is directed to an electronic reader device that includes systems and methods for obtaining electronic content from a server with a client electronic reader device. The content retrieval system and methods include automatically providing the server with reader device identification information when the electronic reader device connects with the server. In one embodiment, the electronic reader device directly connects to the server. Directly connecting includes, for example, a point to point wireline or wireless connection, a connection through a telecommunications switch or a connection via a virtual private network. The server matches the device identification information with user account information. The server then provides information to the electronic reader device that allows a user to select and/or order desired content. In one embodiment, such content is purchasable content. In return, the electronic reader device sends the selections to the server so that the server provides the selected/ordered content to the electronic reader device for rendering and subsequent viewing by the user. These systems and methods reduce time needed to purchase new content, reduce the amount of information needed to be supplied by the user to purchase new content, and enhance the user's purchase experience.

These and other aspects are described below in various illustrative implementations of an electronic reader device. The terms “book” and/or “eBook” are used synonymously and, as used herein include electronic or digital representations of printed and/or digital works, as well as digital content that includes text, multimedia, hypertext and/or hypermedia. Examples of printed and/or digital works include, but are not limited to, books, magazines, newspapers, periodicals, journals, reference materials, telephone books, textbooks, anthologies, instruction manuals, proceedings of meetings, forms, directories, maps, blogs, new feeds, etc. Accordingly, the terms book and/or electronic may include any content that is in electronic or digital format. It is noted, however, that various concepts and features described herein may be implemented in other electronic devices or electronic readers besides electronic reader devices including, for example, personal computers, portable computers (e.g. laptops or pocket PCs), personal digital assistants (PDAs), portable gaming devices, wireless phones, and the like.

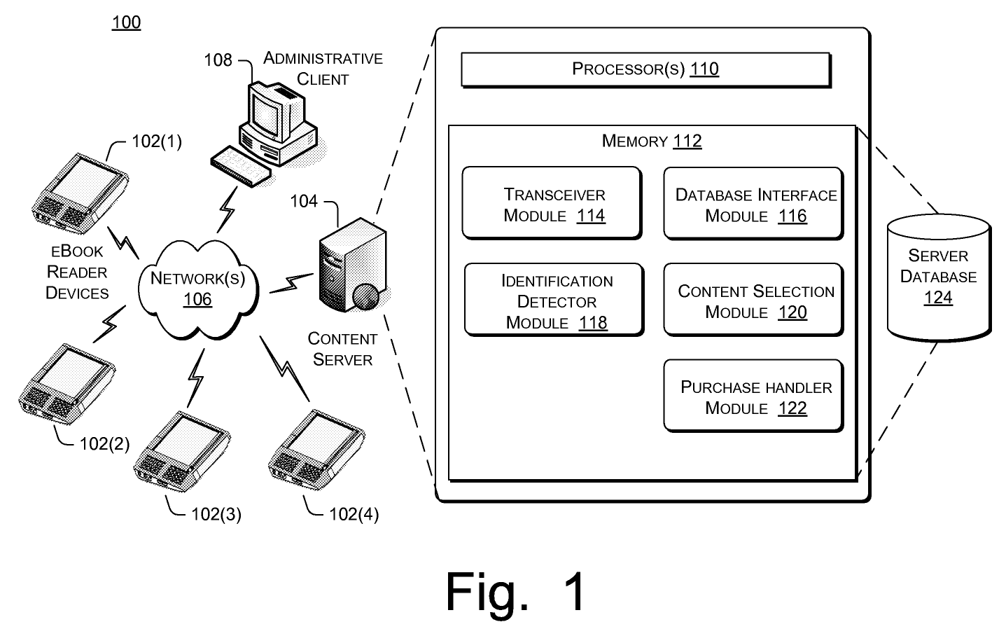

Various illustrations of content purchase and supply management applied to an electronic reader device are described below with reference to FIGS. 1-8.

An electronic book (“eBook”) reader device and a method for operating an electronic reader device are provided wherein the device and method include enhanced purchase management features designed to reduce the time needed to purchase new content, reduce the amount of information required to purchase new content, and enhance the user's purchase experience.

In one reader embodiment, content is obtained from a server by a client electronic reader device. The client device establishes a direct connection with the server and then automatically transmits its identification information to the server. In response, the server provides the client electronic device with icons or symbols corresponding to electronic content available from the server for purchase and/or display. The client electronic reader device displays the symbols so that a user purchases content by selecting the symbol on the display. An indication of the selected symbol is provided to the server. The server acknowledges the selection and provides the client electronic device with the corresponding electronic content. The client electronic reader device receives and automatically displays the electronic content without requiring any additional user input.

In another embodiment, a user account is automatically determined using the identification information originally transmitted by the client electronic reader device upon connection with a server. The electronic content is automatically purchased by debiting the account of the user of the client electronic reader device.

### System Architecture

FIG. 1 depicts an illustrative architecture of system 100 in which electronic reader devices is implemented. In system 100, a plurality of electronic reader devices, including devices 102(A), 102(B), 102(C), and 102(D), can access a content server 104 via one or more networks 106 to exchange content. The one or more networks 106 are representative of any one or combination of multiple different types of networks, such as cable networks, the Internet, and wireless networks. System 100 includes an administrative client 108 that can also access the content server 104. The administrative client 108 allows the management of content that is transmitted to each of the electronic reader devices, including devices 102(A-D).

FIG. 1 further depicts an illustrative implementation of certain components of a content server 104 used to provide content to a plurality of electronic reader devices 102(A-D). The content server 104 has process capabilities and memory suitable to store and execute computer-executable instructions. In this embodiment, the content server 104 includes one or more processors 110 and memory 112. The memory 112 includes volatile and nonvolatile memory, removable and non-removable media implemented in any method or technology for storage of information, such as computer-readable instructions, data structures, program modules or other data. Such memory includes, but is not limited to, Random Access Memory (RAM), Read-Only Memory (ROM), Electrically Erasable Programmable Read-Only Memory (EEPROM), Flash memory or other memory technology, CD-ROM, digital video disks (DVD) or other optical storage, magnetic cassettes, magnetic tape, magnetic disk storage or other magnetic storage devices, Redundant Arrays of Inexpensive Disks (RAID) storage systems, or any other medium which can be used to store the desired information and which can be accessed by a computer system.

Stored in memory 112 are modules 114-122. In one embodiment, modules 114-122 are implemented as software or computer-executable instructions that are executed by one or more processors 110. In another embodiment, modules 114-122 may be implemented as hardware circuits or a combination of a hardware circuit and software. A server database 124 also resides in memory 112.

Transceiver module 114 is used by the content server 104 to communicate with one or more electronic reader devices, including electronic reader devices 102(A-D). Transceiver module 114 includes a software driver which communicates with a communications adapter (not shown). Transciever module 114 is a combination of hardware and software combined to communicate with the reader devices via a network. In one implementation, the transceiver module 114 employs receive device identification information from one or more electronic reader devices, transmit available content to one or more electronic reader devices, receive content selection information from one or more electronic reader devices, and provide the selected content to one or more electronic reader devices. In one embodiment, transceiver module 114 allows direct communication between electronic reader device and server (e.g., allowing direct download of electronic content or eBook to reader device without requiring intermediate server)

A database interface module 116 is configured to access and retrieve content from the server database 124. Content can be delivered to server database 124 and updated in various ways. For example, such content is downloaded dynamically and/or periodically via a network from a computer device. Similarly, such content may be loaded from an electronic storage medium using server 104. Moreover, the database interface module 116 is also configured to read and write identification information, such as device identification information, client information, and client preferences for content, respectively from and into the server database 124.

An identification detector module 118 is configured to detect device identification information for each of the one or more electronic reader devices via transceiver module 114. For example, device identification information for an electronic reader device is a unique numerical identifier, a unique character-based identifier, or a unique alphanumerical identifier. However, one ordinarily skilled in the art will readily recognize that any meaningful symbology or representative data may be used as device identification information for an electronic reader device, provided that the symbology or representative data is used to distinguish the particular electronic reader device from other electronic reader devices.

Additionally, the identification detector module 118 further identifies an electronic reader device, such as an illustrative electronic reader device 102(A), from the corresponding device identification information. Moreover, the identification detector module 118 also identifies the user of the device based on the device identification information. Finally, the identification module 118 activates the content selection module 120 to transmit representation of available content (e.g., one or more symbols) to the electronic reader device, such as electronic reader device 102(A), via transceiver module 114. The one or more symbols typically indicate the electronic content available from the content server 104 that are purchased by the user of the electronic reader device. Further, the one or more symbols transmitted to the electronic reader device 102(A) are pre-selected by the content selection module 120 based on the preferences of the identified user.

A content selection module 120 is employed to obtain the content selection a user makes on an electronic reader device, for example, electronic reader device 102(A), via purchase handler module 122. Based on the content selection of the user, the content selection module 120 is further employed to activate the database interface module 116 to retrieve the selected content from server database 124, and activate the transceiver module 114 to transmit the content to the electronic reader device 102(A). In one implementation, the retrieval and transmission of content, as initiated by the content selection module 122, occurs only after the content selection module receives confirmation from the purchase handler module 122 that the user has purchased the selected content.

A purchase handler module 122 is responsible for managing content purchase requests or declinations originating from one or more electronic reader devices, including electronic reader devices 102(A-D). In this way, the purchase handler 114 allows particular users of one or more electronic reader device to purchase content. In one implementation, the purchase handler module 122 automatically registers a purchase of content by first identifying the user who initiated the purchase request. The purchase handler module 122 makes this identification using account identification information supplied by the identification detector module 118. Once the user is identified, the purchase handler module 122 also automatically debits the account of the user. Such an account is stored as a record in server database 124. In another implementation, the purchase handler also further provides purchase confirmation to content selection module 120.

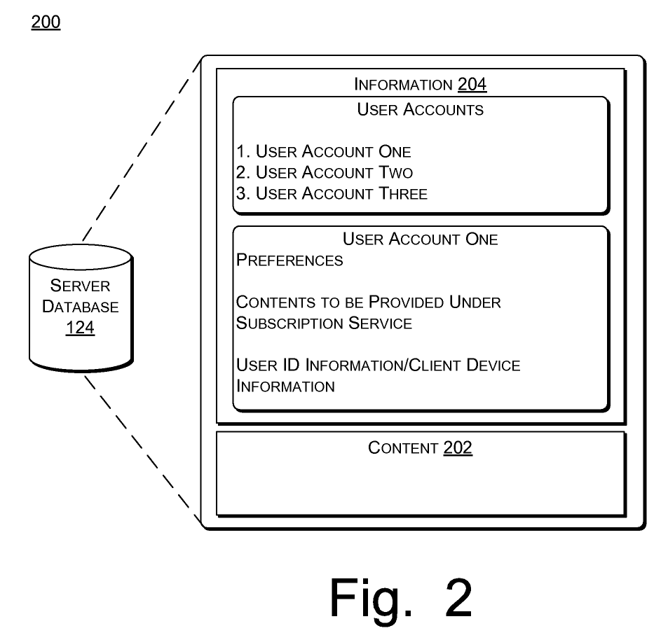

FIG. 2 is a block diagram 200 depicting the contents of a server database 124 in a content server 104. The server database 124 includes content portion 202 and information portion 204. Content portion 202 is employed to electronically store content, example of which includes electronics, electronic media, pictures, video or audio. In one embodiment, symbol or icons for transfer to the electronic reader device is also stored in content portion 202. The symbols correspond to various items of content information.

Information portion 204 contains data that facilitates the delivery of content to electronic reader devices. The data in information portion 204 includes user account information for one or more users. For each individual user, user account information includes client information, that is, identification information regarding each user of the one or more electronic reader devices, including electronic reader devices 102(A-D). For example, client information for a particular user includes one or more of unique identification name, unique account number, electronic reader device network address, unique credit card number, address, email, phone number, and the like. However, one ordinarily skilled in the art will readily appreciate that other information serves as client information for a particular user, provided that the information can be stored, and provided that the client information is useful in the delivery of content.

The information portion 204 further includes device identification information for one or more electronic reader devices, as transferred to the information portion 204 by the database interface module 116. Additionally, the device identification information stored in the server database 124 is correlated by the identification detector module 118 with user account information in such a way that the device identification information of an electronic reader device enables the retrieval of corresponding user account information.

The data in the information portion 204 further includes user preferences for particular content, as well as contents to be provided under subscription. This information is used to determine the content to be provided to the electronic reader device of a particular user. However, one ordinarily skilled in the art will readily appreciation that information portion 204 contains additional information that enables the content server 104 to effectively provide content to one or more users through their respective electronic reader devices, including devices 102(A-D).

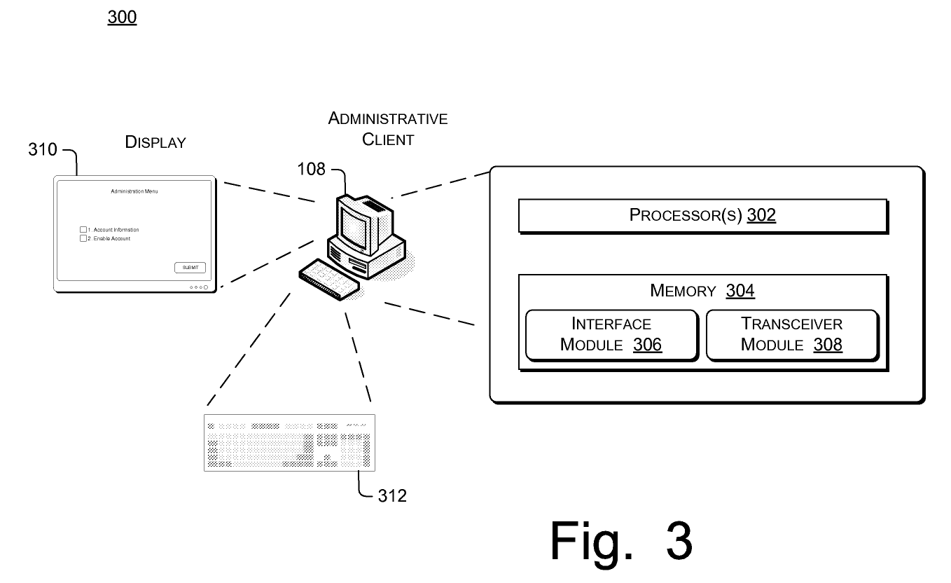

FIG. 3 is a block diagram of a system 300 depicting selected modules in an embodiment of the administrative client 108 coupled with the content server 104 shown in FIG. 1. In this embodiment a user may enter data into the administrative client 108 to manage the transfer of content between server 104 and devices 102 (A-D). In another embodiment, a user of devices 102 (A - D) can enter such data via a web site on server 104 or any computing device. Such data is used to manage content server 104 and to determine which content to transfer. Also such data is initially entered using one of devices 102 (A- D) or using any computing device.

The administrative client 108 has process capabilities and memory suitable to store and execute computer-executable instructions. In this embodiment, the administrative client 108 includes one or more processors 302 and memory 304. The memory 304 may include volatile and nonvolatile memory, removable and non-removable media implemented in any method or technology for storage of information, such as computer-readable instructions, data structures, program modules or other data. Such memory may include, but is not limited to, RAM, ROM, EEPROM, flash memory or other memory technology, Compact Disk-ROM (CD-ROM), digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

As depicted in FIG. 3, an interface module 306 and a transceiver module 308, which communicates with the network 106, reside in memory 304 and are implemented as software or computer-executable instructions that are executed by one or more processors 302. The interface module 306 presents data to an administrator on a display 310, and receives input from an administrator on a user interface 312. The display 310 includes any data presentation device that provides data for output to the user. The user interface 312 includes any input mechanism that enables the administrative client 108 to receive input from the user. The user interface 312 includes, but is not limited to, combinations of one or more of keyboards, keypads, mouse devices, touch screens, microphones, speech recognition packages, and other suitable devices or other electronic/software selection methods.

As further depicted in FIG. 3, the transceiver module 308 serves to communicate with the content server 104. The transceiver module 308 enables the transmission of data from the administrative client 108 to the content server 104, and the reception of data from the content server 104 to the administrative client 108.

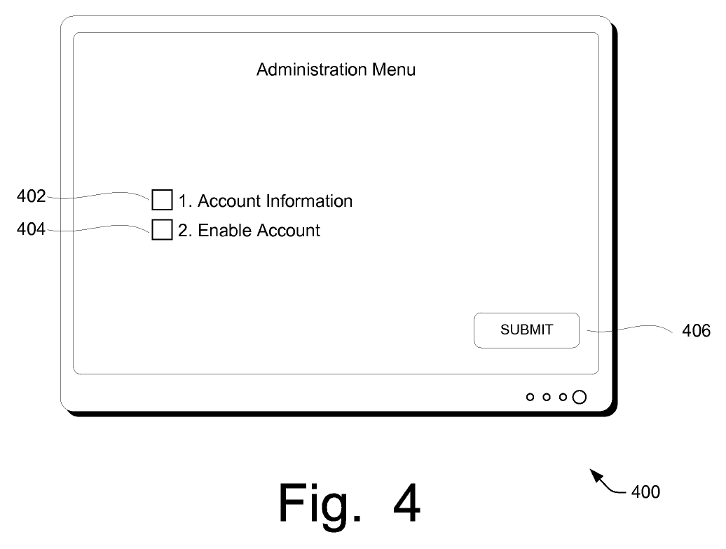

FIG. 4 depicts a screen rendering of an embodiment of a display interface 400 on an administrative client 108, which may be reader 102 or other user computing device (not shown), coupled with a content server 104. (FIG. 1). The display interface 400 is typically shown on the display 310 of the administrative client 108, as discussed in FIG. 3. This illustrative implementation of display interface 400 has an “account information” selection item 402 that enables an administrator to enter the account information for a particular user account that is associated with one electronic reader device, such as one of the devices 102(A-D) (FIG. 1). The display interface 400 is also equipped with an “enable account” item 404 that allows the administrator to enable an account for the user of the electronic reader device. Once the administrator or user has entered and/or selected one or more of items 402-404, the administrator uses a submit icon 406, or another affirmation interface, to provide the settings to the content server 104 via the administrative client 108.

However, one ordinarily skilled in the art will readily appreciate that the content server 104 and the administrative client 108 are configured wherein a variety of other display interfaces may be presented on display 310 in other implementations. These additional implementations enables an administrator or user to control and manipulate other account settings, correlate particular device identification information with particular user account information, modify user account information for one or more users, change the device identification information of one or more electronic device readers, as well as monitor the content server 104 and one or more electronic reader devices.

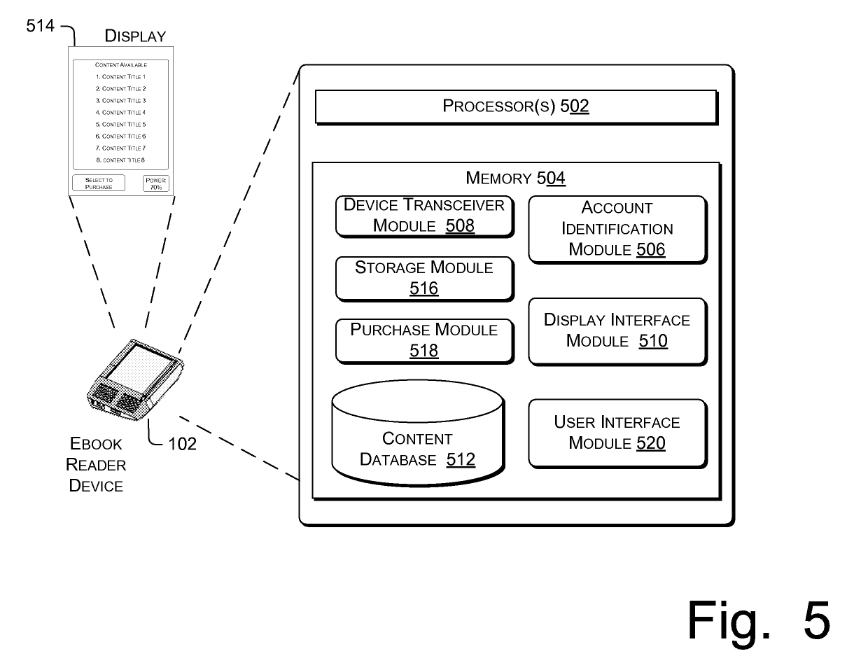

Depicted in FIG. 5 is an illustrative implementation of several components of an electronic reader device, such as electronic reader device 102(A), used to display content received from the content server 104. The electronic reader device 102(A) has process capabilities and memory suitable to store and execute computer-executable instructions. In this embodiment, the electronic reader device 102(A) includes one or more processors 502 and memory 504. The memory 504 includes volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology suitable for implementation in a portable device.

Modules 506-510 and 516-520 are stored in memory 504. Modules 506-510 and 516-520 are implemented as software or computer-executable instructions to be executed by one or more processors 502. A device transceiver module 508 is employed to communicate with the content server 104 via one or more networks 106. In one embodiment, module 508 is implemented as a driver which communicates with a network adapter (not shown). The transceiver module 508 is configured to send device identification information of the electronic reader device, receive symbols from the content server 104, transmit user content selection to the content server 104, and receive content transmitted by the content server 104.

An account identification module 506 is configured to store device identification information of the electronic device 102(A). In addition, the account identification module 506 is further configured to automatically activate the device transceiver module 508 to transmit the device identification information to the content server 104 when the device transceiver module 508 initially establishes communication with the content server 104 via one or more networks 106. In another implementation, the account identification module 506 is configured to periodically transmit device identification information to the content server 104 via transceiver module 508. In one embodiment, the identification information is transmitted using standard communications protocols. In such an embodiment, the identification information includes a media access control address, a network identification address or a pre-stored unique identifier of the reader device.

In this way, device identification information is transmitted from the illustrative electronic reader device 102(A) without any human intervention on the part of the user of the electronic reader device 102(A). In turn, the automatic transmission of device identification information allows the content server 104 to automatically deliver symbols or icons representing content to the electronic reader device 102(A) without any deliberate action on the part of the user.

Additionally, device identification information stored in the account identification module 506 is updated by the content server 104. In one implementation, an administrator uses the administrative client 108 to connect with the content server 104 to update device identification information stored in the account identification module 506.

A display interface module 510 is configured to present the content stored in the content database 512 on a display 514 of the electronic reader device 102(A). Displayed content includes, for example, an eBook, an electronic magazine, an electronic newspaper, and an electronic photograph. However, one ordinarily skilled in the art will readily appreciate that other content, including other audio, video and/or visual content, as stored in content database 512, is presented by display interface module 510 on the display 514. Furthermore, the display interface module 510 also displays symbols received from the content server 104 via the transceiver module 508. As discussed above, the symbols, in one embodiment, generally indicate the purchasable content available on the content server 104. Additionally, the display interface module 510 also displays additional data and symbols or icons that enable the user to view and purchase content.

A storage module 516 is configured to transfer purchased content to the content database 512. Content stored in the content database 512 includes an eBook, an electronic magazine, an electronic newspaper, and an electronic photograph. However, one ordinarily skilled in the art will readily appreciate that other content, including other audio and/or visual content, is stored in the content server 512. In addition, content database 512 also is configured to store one or more symbols received from content server 104.

A purchase module 518 enables the user of the electronic reader device 102(A) to purchase content stored in the content server 104. The user initially selects a symbol corresponding to the content to be purchased using the user interface module 520. Once the user has selected the content (e.g., using symbol), the purchase module 518 then automatically retrieves the device identification information from account identification module 506, and transmits the retrieved device identification information along with the content selection. In this way, the user of the electronic reader device 102(A) purchases the selected content without the need to supply account identification information at the time of the purchase.

A user interface module 520 is used to receive input from the user of the illustrative electronic reader device 102(A). The user interface module 520 receives inputs from one or more user interfaces on the electronic reader device 102(A). These inputs enable the user of the electronic reader device 102(A) to manipulate and view the content stored on the content database 512. Additionally, the user interface module 520 also receives inputs that enable the user to select content stored on the content server 104. Further, the user interface module 520 allows the user to select content represented by the symbols displayed by the display interface module 510.

In instances where the user simultaneously selects content (e.g., via a plurality of symbols representing content stored on content server 124 that are available for purchase), the purchase module 518 coordinates with the purchase handler module 122 on the content sever 104 so that the plurality of selected content are purchased simultaneously using the same device identification information. As described above, the plurality of purchased content are then stored in the content database 512 by the storage module 516 once the purchase transaction is complete and the purchased content are provided to the electronic reader device 102(A).

However, in another implementation, the plurality of content is purchased in separate sequential transactions, each transaction involving the transmission of the content selection and device identification information. For each transaction, the purchase content is also stored in the content database 512 by the storage module 516,

Moreover, in one embodiment, the display interface module 510 is configured to automatically display a plurality of symbols corresponding to the plurality of purchased content, regardless of whether the transactions are processed simultaneously or sequentially.

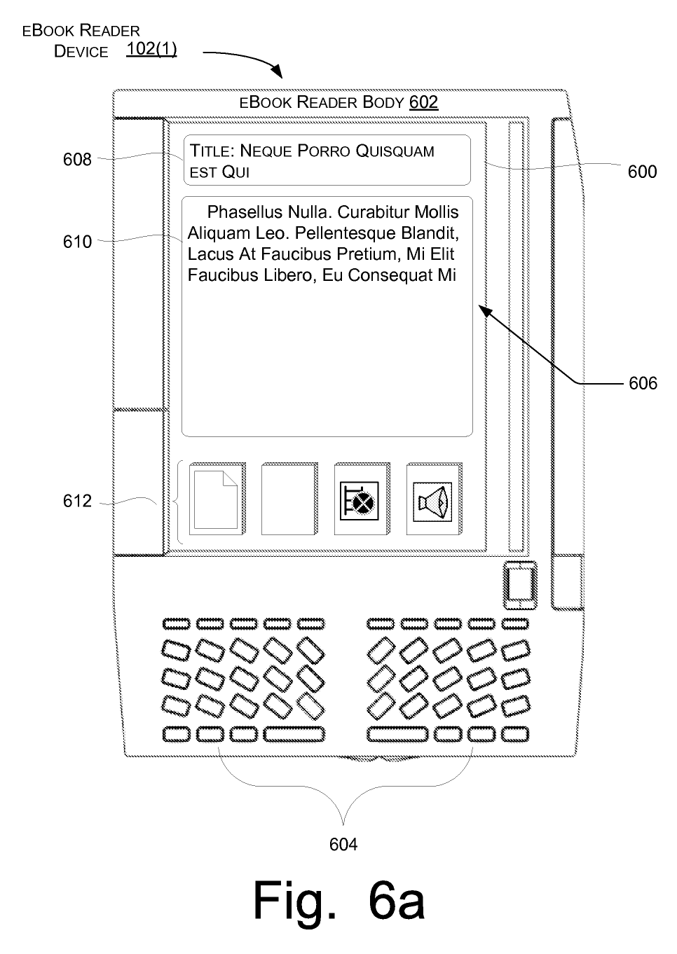

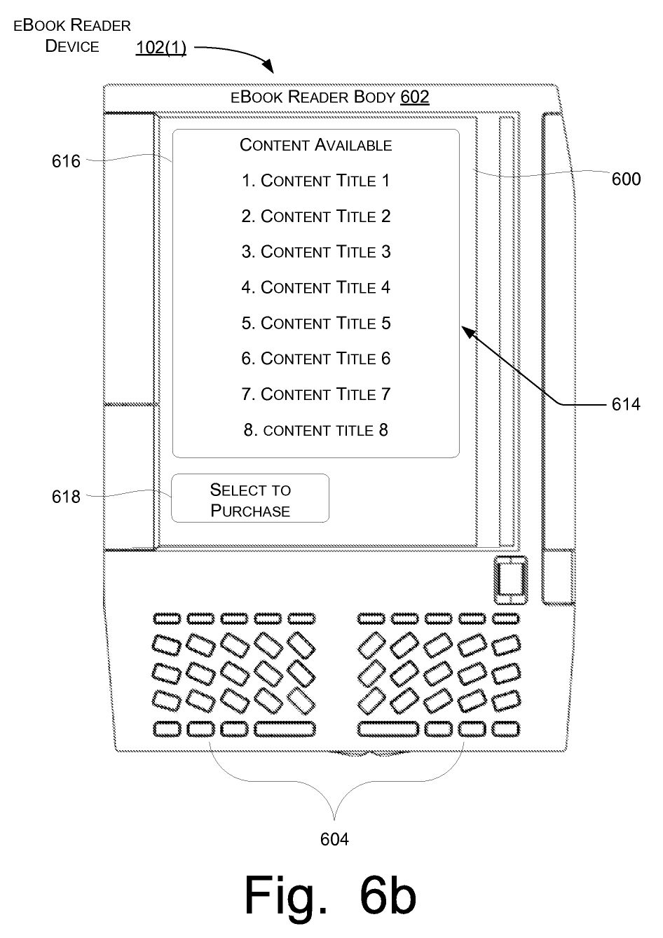

FIGS. 6a and 6b depict illustrative screen renderings of a display 600 of an illustrative electronic reader device 102(A). The display 600 is housed in the body 602 of an illustrative electronic reader device 102(A). The body 602 of the electronic reader device 102(A) is also equipped with user interface 604 that enables a user to interact with the electronic reader 102(A). In addition, the display 600 is a type that both displays data and receives data inputs from a user, such as a touch screen.

FIG. 6a depicts an illustrative screen 606 rendering that assists the user in purchasing or displaying content. The display 600 is configured to receive user inputs through the manipulation of designated portions, including area 606 of the illustrative screen 606. Illustrative screen 606 is further configured to display content information, such as the content of an eBook, in title area 608 and content area 610. Moreover, the types of content available for purchase and/or display, or content stored in database 512 that are available for viewing is displayed in areas 612 in the form of symbols or icons. Types of content represented by the symbols include eBooks, electronic magazines, electronic newspapers, and electronic photographs. The user selects the type of content either using the user interface 604 or the manipulation of symbols in area 612.

Furthermore, FIG. 6b further depicts an electronic reader device 102(A) with an illustrative screen 614 that allows a user to input user selection of content. The selection of content is then transmitted to the content server 104 by the electronic reader device 102(A). The illustrative screen 614 is displayed on display 600 after a user has selected the type, title or genre of content displayed on illustrative screen 606. In this implementation, a list of content available under the type of content is displayed in area 616. For example, if the user has previously selected eBooks as the type of content in screen 606, area 616 displays a list of eBook titles or content available for purchase. On the other hand, if the user has previously selected electronic magazines as the type of content in screen 606, area 616 displays a list of electronic magazine titles available for purchase. In one embodiment, screen 614, like screen 606, is capable of receiving user input. Thus, the user has the ability to use either user interface 604, or one or more designated areas of screen 614, including area 618, to input user selections for content to be purchased.

### Process

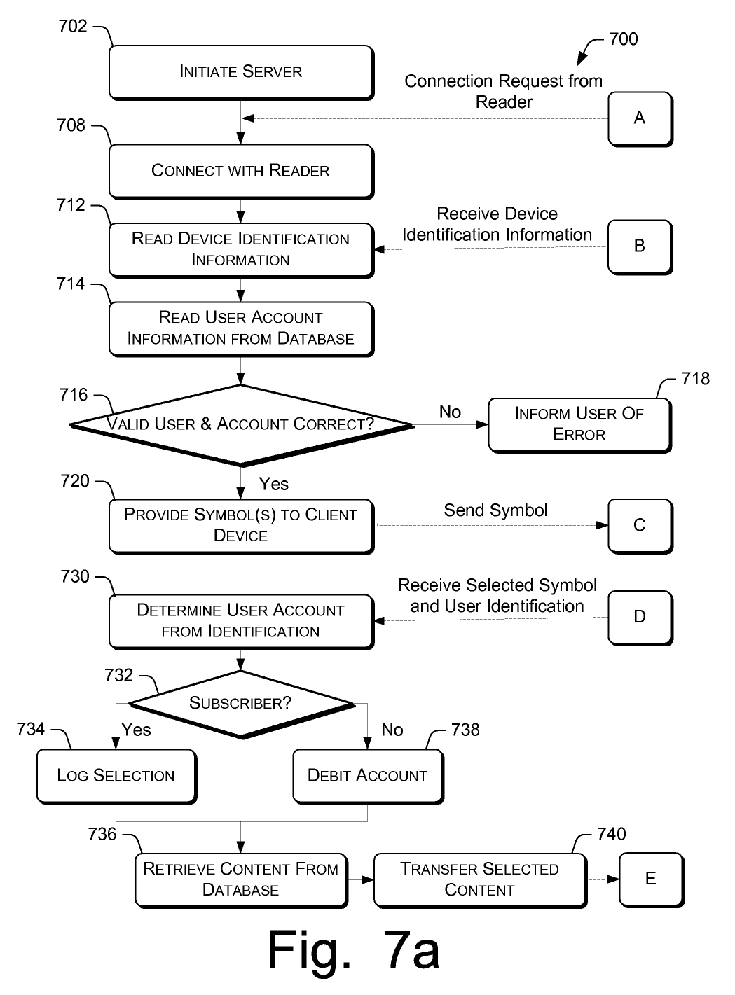

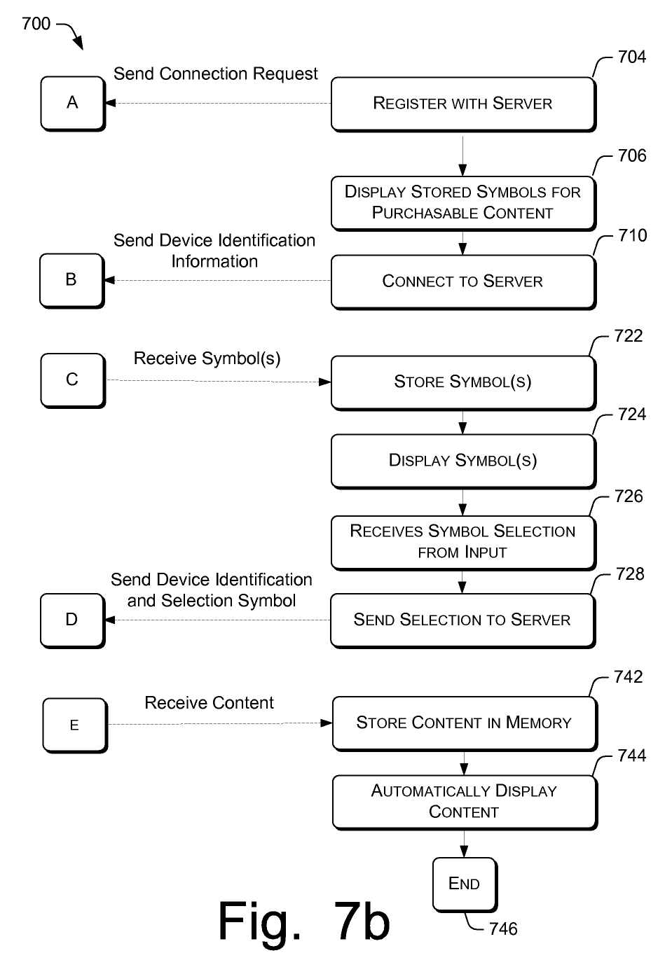

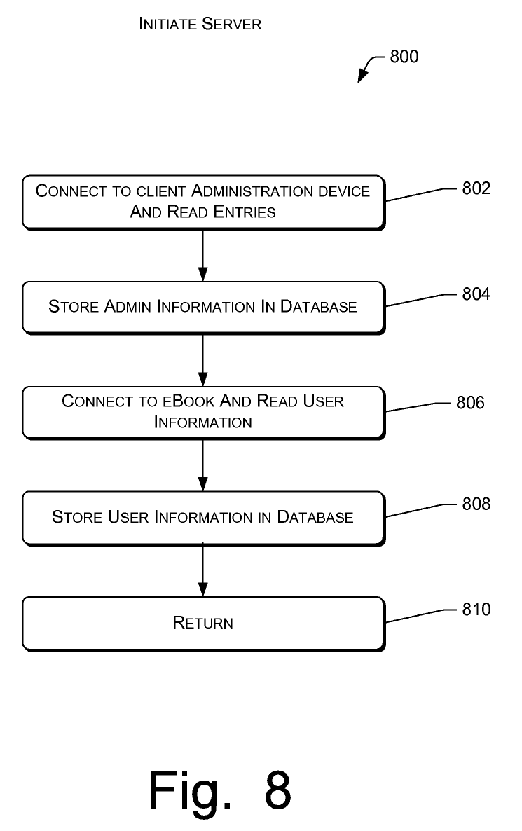

FIGS. 7a, 7b, and 8 depict processes for the transfer of content from a content server to an electronic reader device. The processes are depicted as a collection of blocks in a logical flow diagram, which represents a sequence of operations that can be implemented in hardware, software, and a combination thereof. In the context of software, the blocks represent computer-executable instructions that, when executed by one or more processors and/or additional hardware, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the process is described with reference to the system 100 of FIG. 1, although it may be implemented in other system architectures.

FIGS. 7a and 7b depict a flow diagram of a process, in accordance with one embodiment, for providing content from a content server to an electronic reader device. FIG. 7a is the process executed by the content server 104, and FIG. 7b is the process executed by the electronic reader device 102. At block 702, a content server 104 is initiated by connecting to an administrative client 108, so that the content server 104 is ready to communicate with an electronic reader device, such as an illustrative electronic reader device 102(A). More details of the process for initiating the server is described in FIG. 8.

At block 704, the electronic reader device 102(A) is powered on by a user. Upon power on, the electronic reader device 102(A) automatically attempts to register with the content server 104 by sending a connection request to establish communication with content server 104. Moreover, the electronic reader 102(A) further uses the display interface module 510 to automatically display stored symbols that represent purchasable content at block 706 when the electronic reader device 102(A) is initially powered on.

At block 708, the content server 104 responds to the connection request by directly connecting with the electronic reader device 102(A). Once a direct connection between the content server 104 and the electronic reader device 102(A) is established at the block 710, the electronic reader device 102(A) uses the account identification module 506 to send its device identification information to the content server 104 via the transceiver module 508. Although a direct connection is described to connect server 104 and reader device 102(A), content server 104 indirectly connects with server by connecting for example through an intermediate device, such as a proxy server.

At block 712, the content server 104 receives the device identification information via transceiver module 114, and then read the received device identification information using the identification detector module 118. Based on the received device identification information, the identification detector module 118 further employs the database interface module 116 to retrieve the corresponding client information, that is, user account information, from the server database 124 at block 714. At decision block 716, the identification detector module 118 determines as to whether the retrieved user identification is valid as well as whether the retrieved account information is correct. If the user identification is invalid and/or the account information is incorrect (“no” to block 716), the identification detector module 118 transmits an error message to the electronic reader device 102(A) via the transceiver module 114 and transceiver module 508, respectively. The error message is then displayed to the user of the electronic reader device 102(A) by the display interface module 510.

However, if the identification detector module 118 at block 716 determines that the user identification is valid and the retrieved account information is correct (“yes” to block 716), the identification detector module 118 then enables the content selection module 120 to provide one or more symbols to the electronic reader device 102(A) in block 720. As discussed above, the symbols represent purchasable content, such as an eBook, an electronic magazine, an electronic newspaper, or an electronic photograph.

At block 722, the electronic reader device 102(A) receives available content (e.g., via the one or more symbols) from transceiver module 508 and store them in the content database 512. At block 724, the display interface module 510 displays the content (e.g., symbols) to a user via a display. Once the available content (e.g., symbols) is displayed and the user makes a selection, the user interface module 520 receives the selection input at block 726. The electronic reader device 102(A) then activates the purchase module 518 to send the selected content (e.g., one or more selected symbols), together with the device identification retrieved from the account identification module 506, to the content server 104 via transceiver module 508 at block 728. By employing transceiver module 114, the content server 104 receives the selected content (e.g., symbol) and the device identification information at block 730.

Further at block 730, the content server 104 determines the corresponding user account information using identification detector module 108. The identification detector module 108 ascertains the account information by accessing the information portion 204 of the server database 124 via the database interface module 116, and attains account information that correlates with the device identification information for eventual retrieval at block 736.

At decision block 732, the identification detector module 108 determines whether the account information indicates that the user is a subscriber of the content, wherein a subscriber is entitled to the content at no cost or other determined cost. If the identification detector module 108 determines that the user is a subscriber (“yes” to block 732), the identification detector module 108 then enables the content selection module 120 to log the selection represented by the selected symbol at block 734.

Returning to decision block 734, if the identification detector module 108 determines that the user is not a subscriber of the selected content (“no” to block 732), the identification detector module 108 then supplies the purchase handler module 122 with the user's account information at block 738. Once the purchase handler module 122 is supplied with the user's account information, the purchase handler module 122 determines a price and automatically debits the account of the user the price at block 738. The purchase handler module 122 also sends a purchase confirmation to content selection module 120 so that the content selection module 120 retrieves the content at block 736.

At block 736, the content selection module 120 retrieves the content from the content portion 202 of the server database 124 using the database interface module 116. From block 736, the process proceeds to block 740, where the content is directly (for example, without an intermediate networked device) transferred from the content server 104 to the electronic reader device 102(A) via the network using transceiver module 114 and transceiver module 508, respectively.

At block 742, the electronic reader device 102(A) uses the storage module 516 to store the content in content database 512. At block 744, the display interface module 510 automatically displays the content on a display 600 of the electronic reader device before the process terminates at block 746. Alternatively, the display interface displays icons corresponding to additional downloaded content stored in the memory of electronic reader device that is available for display.

FIG. 8 depicts a flow diagram of one embodiment of a process 800 for initiating a content server 104 to provide content 202 from the content server 104 to an electronic reader device 102. Process 800 further depicts block 702 of process 700, as shown in FIG. 7a. At block 802, the content server 104 connects with the administrative client 108 and obtains administrative entries that includes a time to transmit content, categories of content available to the user, user preferred content, services subscribed to by the user, and user account information. At block 804, the content server 104 stores or updates these administrative entries in a server database 124.

At block 806, the content server 104 directly or indirectly connects to the electronic reader device 102(A) via one or more networks 106 using the transceiver module 124 and reads the user information stored in memory or integrated circuits of electronic reader device 102(A). In one implementation, the user information includes device identification information.

At block 808, the content server 104 stores or updates the device identification information obtained at block 806 in a server database 124. Once the user information has been stored, the process returns to block 704 of the process 700.

### Conclusion

In closing, although the invention has been described in language specific to structural features and/or methodological acts, it is to be understood that the invention defined in the appended claims is not necessarily limited to the specific features or acts described. Rather, the specific features and acts are disclosed as illustrative forms of implementing the claimed invention.

What is claimed is:

1. A method for directly transferring electronic content from a server to an electronic reader device, the method comprising:
establishing a direct connection between the server and the electronic reader device;
upon establishment of the connection, automatically transmitting identification information of the electronic reader device to the server;
directly transferring from the server a list of electronic content available from the server;
directly transferring from the server to the electronic reader device selected electronic content; and
storing the selected electronic content into a memory of the electronic reader device.

2. The method as recited in claim 1 further comprising providing an indication to the server with the electronic reader device of the selected content, and automatically acknowledging by the server purchase of content selection.

3. The method as recited in claim 1 wherein the electronic content is selected from the group of electronic content comprising: an eBook, and electronic magazine, an electronic newspaper and an electronic photograph.

4. The method as recited in claim 1 wherein the selected content is automatically purchased by debiting an account of the user of the electronic reader device on a server, wherein the account is automatically determined using the identification information.

5. The method as recited in claim 1 wherein the establishing, transmitting, receiving and transferring is done automatically without human intervention.

6. The method as recited in claim 1 wherein the server and electronic reader device is directly connected using a wireless connection.

7. A method for delivering electronic content from a server to an electronic reader device, the method comprising:
establishing a connection between the server and the electronic reader device;
upon establishment of the connection, automatically receiving with the server the identification information of the electronic reader device;
transmitting from the server to the client electronic device content available on the server for purchase;
receiving an indication from the electronic reader device of a selection of the content;
automatically purchasing the content corresponding to the selection using the identification information; and
transmitting from the server the purchased electronic content for storage into a memory of the electronic reader device and for display by the electronic reader device.

8. The method as recited in claim 7 wherein the electronic content is selected from the group of electronic content comprising: an eBook, and electronic magazine, an electronic newspaper and an electronic photograph.

9. The method as recited in claim 7 wherein the automatic purchase of the content occurs by debiting an account of the user of the electronic reader device on a server, and wherein the account is automatically determined using the identification information.

10. The method as recited in claim 7 wherein the establishing, receiving, and transmitting the purchase is completed without human intervention.

11. The method as recited in claim 7 further comprising storing identification information about a user of a electronic reader device in a database of the server prior to establishing connection between the server and the electronic reader device.

12. The method as recited in claim 7 wherein a connection between the server and electronic reader device are directly connected and such direct connection is established using a wireless connection.

13. A method for obtaining electronic content from a server with an electronic reader device, the method comprising:
establishing a direct connection between the server and the electronic reader device;
upon establishment of the connection, automatically transmitting identification information of the electronic reader device to the server;
receiving from the server a list of representative content available from the server and previously purchased by a user of the electronic reader device;
selecting content from the list;
providing an indication to the server with the electronic reader device of the content selection, wherein the identification information is used by the server to verify an identity of the user prior to purchase of corresponding electronic content; and
receiving from the server electronic content corresponding to the content selection.

14. The method as recited in claim 13 further comprising automatically displaying the stored content on the display of the electronic reader device.

15. The method as recited in claim 13 wherein the electronic content is previously purchased pursuant to a subscription service.

16. The method as recited in claim 13 further comprising:
selecting additional content on the display;
providing an indication to the server with the electronic device of the additional content selection; receiving from the server electronic content corresponding to the second content selection;
storing the received additional content in the memory of the client electronic device; and
automatically displaying a representation corresponding to the additional stored content with the display.

17. A computer readable medium comprising computer-executable instructions for performing:
establishing a virtual connection with a server via a network;
upon establishment of the virtual connection, automatically transmitting identification information to the server;
receiving from the server a representation indicating electronic content available from the server for purchase;
receiving an indication of a selection of content;
providing the received indication to the server such that the server acknowledges a purchase of content corresponding to the content selection;
receiving from the server electronic content corresponding to the content selection; and
storing the received electronic content.

18. The computer readable medium as recited in claim 17, further comprising displaying the stored content.

19. The computer readable medium as recited in claim 17, wherein the content is automatically purchased by debiting an account of the user of the electronic reader device with the server, wherein the account is automatically determined using the identification information.

20. A computer readable medium comprising computer-executable instructions that, when executed by one or more processors, perform acts comprising:
establishing a virtual direct connection with an electronic reader device;
upon establishment of the connection, automatically receiving the identification information of the electronic reader device;
transmitting to the client electronic device representations indicating the electronic content available, said representations being displayable on a display of the electronic reader device;
receiving an indication from the electronic reader device of a selection of representations made by a user of the electronic reader device;
automatically registering a selection of the content corresponding to the symbol selection using the identification information; and
transmitting the selected electronic content for storage into a memory of the electronic reader device and for subsequent display by the electronic reader device.

21. The computer readable medium as recited in claim 20 wherein the automatically registering of a selected of the content occurs by debiting an account of the user of the electronic reader device, and wherein the account is automatically determined using the identification information.

22. The computer readable medium as recited in claim 20 further comprising storing identification information about a user of a electronic reader device in a database prior to establishing a virtual connection with the electronic reader device.

23. The computer readable medium as recited in claim 20 further comprising automatically displaying the selected electronic content.

24. An electronic reader device comprising:
a transceiver module to establish a connection with a server via a network, upon establishment of the connection, to automatically transmit identification information to the server, and to receive from the server a representation indicating electronic content available from the server for purchase;
a display;
an input device;
a display interface module to display the representation on the display;
a user interface module to receive a selection of the representation on the display from the input device;
said transceiver module to provide an indication to the server of the representation selection wherein a purchase of content corresponding to the symbol selection being automatically acknowledged by the server, and to receive from the server electronic content corresponding to the representation selection;
storage module to store the received electronic content into a memory; and
said display interface module to provide the stored received electronic content to the display.

25. The method as recited in claim 24 wherein the purchase of the content is acknowledged by debiting an account on the server, wherein the account is automatically determined using the identification information.
